(19) United States
(12) Patent Application Publication
(10) Pub. No.: US 2003/0149647 A1
(43) Pub. Date: Aug. 7, 2003

(54) System and method for management of debt default information

(75) Inventor: David H. Youngblood JR., Austin, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(73) Assignee: T4S, Inc., Austin, TX

(21) Appl. No.: 10/071,265

(22) Filed: Feb. 6, 2002

(51) Int. Cl. G06F 17/60

(52) U.S. Cl. 705/35

(57) ABSTRACT

A system and method for management of debt default information is disclosed. The system comprises a debt default database for storing a plurality of records, each record having data associated with a defaulted loan; a certified numbering module operable to generate a plurality of unique certified numbers, each certified number including an identifier of a lender of the defaulted loan and an identifier of the service provider, the certified numbering module further operable to assign each of the plurality of unique certified numbers to respective ones of the plurality of records; and a document creation module operable to create correspondence to be communicated to debtors associated with the defaulted loans using the assigned unique certified numbers.

### TECHNICAL FIELD OF THE INVENTION

The present invention relates generally to the field of information management, and more particularly to a system and method for management of debt default information.

### BACKGROUND OF THE INVENTION

In times of economic hardship, many debtors start defaulting on their loans. As the economic uncertainty increases, so does the number of people defaulting. Debt collection is a highly regulated area and there are numerous state and federal laws regulating the collection of debt from defaulting debtors, such as the Fair Debt Collection Practices Act. Therefore, it is critical to keep track of and document communications sent to and received from a defaulting debtor. The documentation and management of data and each contact made with the debtors is not only crucial in order to perform the various tasks directly related to debt collection, it is also very important for defensive purposes to show compliance with the federal and state regulations. With the increase in the number of defaulting debtors, it becomes increasingly difficult to document and manage the flow of information from and to the various debtors.

### SUMMARY OF THE INVENTION

There is a need for a system and method for the management of debt default information, such as communications to and from a defaulting debtor.

In accordance with an embodiment of the present invention, a method for management of debt information by a service provider is disclosed. The method comprises receiving a debt default data file, the debt default data file comprising a plurality of records, each record having data associated with a defaulted loan; importing the plurality of records into a debt default database; generating a plurality of unique certified numbers, each certified number including an identifier of a lender of the defaulted loan and an identifier of the service provider; assigning each of the plurality of unique certified numbers to respective ones of the plurality of records; and generating correspondence and communicating with debtors associated with the defaulted loans using the assigned unique certified numbers.

In accordance with another embodiment of the present invention, a system for management of debt information by a service provider is disclosed. The system comprises a debt default database for storing a plurality of records, each record having data associated with a defaulted loan; a certified numbering module operable to generate a plurality of unique certified numbers, each certified number including an identifier of a lender of the defaulted loan and an identifier of the service provider, the certified numbering module further operable to assign each of the plurality of unique certified numbers to respective ones of the plurality of records; and a document creation module operable to create correspondence to be communicated to debtors associated with the defaulted loans using the assigned unique certified numbers.

Other aspects and features of the invention will become apparent to those ordinarily skilled in the art upon review of the following description of specific embodiments of the invention in conjunction with the accompanying figures.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a top-level diagram of an exemplary system in which a debt default management system of the present invention may be used;

FIG. 2 is a block diagram of a debt default management system in accordance with an embodiment of the present invention;

FIG. 3 is a flowchart illustrating the general flow of debt default information in accordance with an embodiment of the present invention;

FIGS. 4A-4E are flowcharts for processing records in a debt default database in accordance with an embodiment of the present invention;

FIG. 5 is a flowchart of a method for attaching a debtor letter to a loan record in accordance with an embodiment of the present invention;

FIG. 6 is a flowchart of a method for processing an acknowledgment in accordance with an embodiment of the present invention;

FIG. 7 is a flowchart of a method for processing a voicemail message in accordance with an embodiment of the present invention; and

FIG. 8 is a flowchart of a method for processing an email message in accordance with an embodiment of the present invention.

### DETAILED DESCRIPTION OF THE DRAWINGS

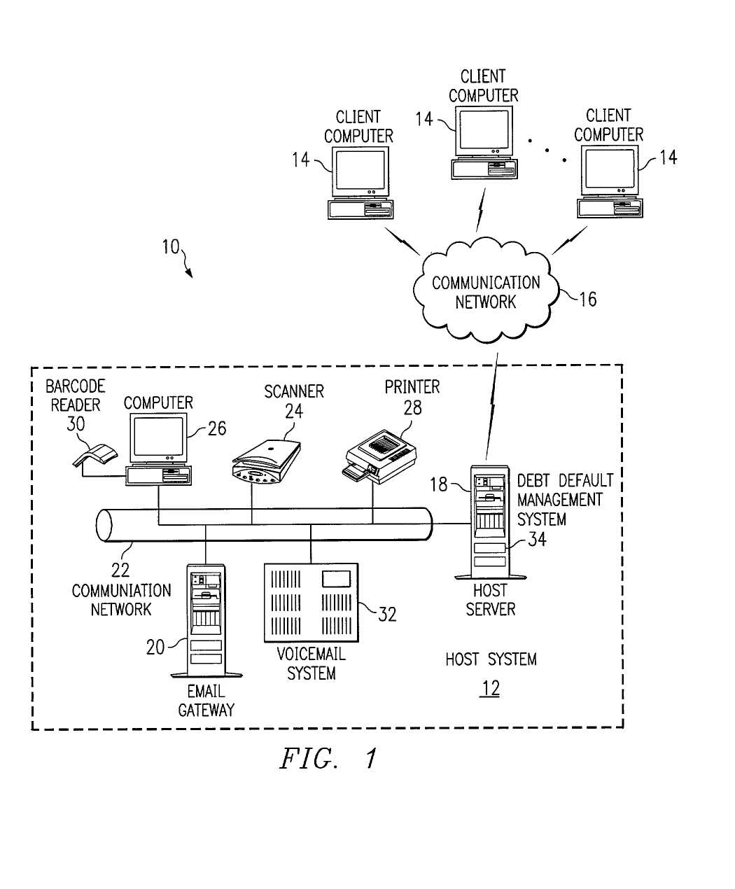

The preferred embodiment of the present invention and its advantages are best understood by referring to FIGS. 1 through 8 of the drawings.

FIG. 1 is a top-level diagram of a system 10 in which a debt default management system of the present invention may be used. System 10 comprises a host system 12 networked with one or more client computer(s) 14 via a communication network 16. Host system 12 preferably comprises a host server 18 coupled to an email gateway 20 via a communication network 22, such as a local area network (LAN). If desired, a scanner 24, a host computer 26, a printer 28 and a voicemail system 32 may also be coupled to host server 18 via communication network 22. If desired, a barcode reader 30 may be coupled to host computer 26.

Host server 18 preferably acts as a web server and may also serve as a repository for certain data and computer application programs as described in more detail below. Host server 18 may be any computing device such as a network computer running Windows NT, Novell Netware, Unix, Windows 2000 or any other network operating system. If desired, host server 18 may be connected to another computing device (not shown) that serves as a firewall to prevent tampering with information stored on or accessible from host server 18. In an alternative embodiment, the firewall may be part of host server 18. If desired, other security measures, such as the use of user ID, passwords, retinal scans, fingerprints, facial recognition, voice recognition, and/or the like, may be used to restrict access to information stored on or accessible from host server 18.

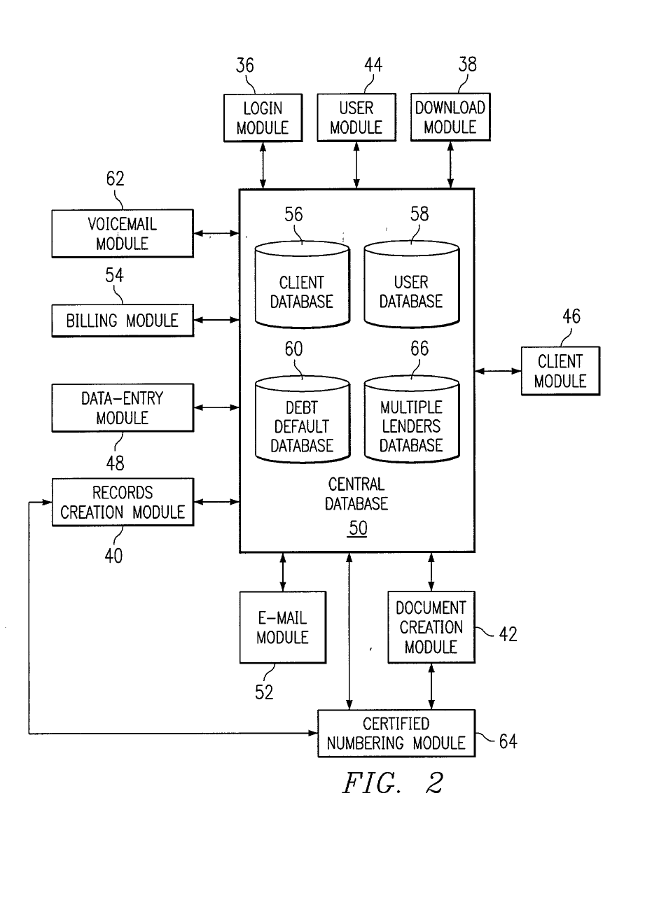

Host server 18 preferably includes conventional web hosting operating software and includes a device for connecting with the Internet, such as a dial-up modem, a cable modem, a wireless modem, a wireless gateway, a xDSL modem, or an ISDN converter. Host server 18 is preferably under the control of a provider of services for debt default management, such as a law firm, a mortgagor, a mortgage servicer, a lender and/or the like. In the preferred embodiment, host server 18 is coupled to or comprises a debt default management system 34. Debt default management system 34 preferably serves as a central repository for information, such as documents, emails, voicemails, and/or the like. The operation and function of debt default management system 34 is described in more detail herein with reference to FIG. 2.

Client computer 14 may be a stand-alone device or multiple computers networked together via a communication network (not shown). Each client computer 14 preferably includes a device such as a dial-up modem, a cable modem, a wireless modem, a wireless gateway, a xDSL modem, or ISDN converter and a web browser that permits it to access the Internet via communication network 16. In the preferred embodiment, communication network 16 may comprise a public network. In alternative embodiments, communication network 16 may comprise any means of information communication, such as PSTN, wireless communication network, a proprietary network, a general purpose processor-based information network, dedicated communication lines, a computer network, direct PC-to-PC connection, a local area network, a wide area network, modem to modem connection, an Intranet, an Extranet, a Virtual Private Network (VPN) or any combination thereof suitable for providing information to and from client computer 14.

Client computer 14, such as personal computers (PCs), workstations, laptop computers, personal digital assistants (PDAs), wireless phones and/or the like, may be used by users, such as lawyers, paralegals, representatives of mortgagors and lenders, providers of services related to management of debt default information, and/or the like, to access debt default management system 34.

Email gateway 20 may be used to process emails to and from client computers 14. Computer 26 may be used to access debt default management system 34 of host server 18. Computer 26 may also be used to control scanner 24, printer 28 and barcode reader 30. Voicemail system 32 may be used to store voicemails.

FIG. 2 is a block diagram of debt default management system 34 in accordance with an embodiment of the present invention. System 34 preferably employs a web browser-based user interface. System 34 comprises a login module 36, a download module 38, a records creation module 40, a document creation module 42, a user module 44, a client module 46, a data entry module 48, an email module 52, a billing module 54, a voicemail module 62, and a certified numbering module 64. Each of these modules are operable to access a central database 50. Preferably, certified numbering module 64 can communicate with records creation module 40 and document creation module 42.

Preferably, central database 50 comprises a client database 56, a user database 58, a debt default database 60 and a multiple lenders database 66. Each database may be a relational database and comprise one or more data tables. Each data table may be conceptually envisioned as having a plurality of rows and columns, where each row corresponds to a record and each column corresponds to a field of the record. Client database 56 preferably includes client information, such as client code, client name, client preferences, client contact information, for example, address(es), phone number(s), fax number(s), email address(es), and/or the like. Client preferences may include information, such as a client's preferred method for receiving invoices, fee structures of the particular client, and/or the like. If desired, client preferences may be stored in a client preference database (not shown) separate from client database 56. In such a case, the client code may be used as the primary key to relate client database 56 with the client preference database.

User database 58 preferably includes user information, such as user ID, name of the user, password information, user status, email address of the user, last login information, user preferences and/or the like. User ID is preferably a unique identification associated with a user account. User status is used to determine the level of system access provided to a particular user. For example, a user with Administrator status may be able to create new user accounts and control the level of access of other users. A user with the Administrator status may grant user access to other users to debt default management system 34.

Debt default database 60 preferably includes debt default information, such as loan records imported from debt default data files, voicemails, emails, manually entered data, image files, documents created within debt default management system 34, and/or the like. Debt default database 60 may be logically subdivided into different portions, each portion corresponding to a particular client of the provider of debt default management services. Records in debt default database 60 may include one or more of the following fields: loan number, debtor name, client number, principal due date, principal amount, mailing address, property address, lender ID code, late fee date, last payment missed date, date, certified number, and/or the like.

Multiple lenders database 66 preferably includes information about special loan records. Records in multiple lenders database 66 may include one or more of the following fields: loan number, lender's name, ID of the lender, cure period, and/or the like. The information in multiple lenders database 66 facilitates compliance with the Fair Debt Collection Practices Act by facilitating inclusion of accurate information in letters sent to debtors as discussed in greater detail herein.

Login module 36 is primarily responsible for providing access to central database 50 to an authorized user. Login module 36 interacts with user database 58 to verify the login and other security information provided by the user and also to determine the level of access to be provided to a particular user.

Download module 38 is primarily responsible for enabling the downloading of documents and/or data, such as a debt default data file, stored at a remote location, such as for example client computer 14. A download log may be maintained to keep track of debt default data files that have been downloaded and other download data, such as the date and time of the download. Thus, duplicate data downloads may be avoided. If desired, multiple debt default data files may be received from the same client or from different clients in the same day.

Records creation module 40 is primarily responsible for extracting the records from the debt default data file and storing them in debt default database 60. A client, such as a mortgagor, a mortgage servicer, and/or a lender, of the debt default management service provider may create a debt default data file comprising records of debtors in default. The debt default data file includes information relevant to starting the debt collection process. Preferably, each debt default data file comprises information for debtors in default for a particular client for a particular time period. The records in the debt default data file may include information, such as, loan number, debtor name, principal due date, principal amount, mailing address, property address, lender ID code, late fee date, last payment missed date, referral date, etc. The data file may be in any format, such as text, spreadsheet, comma delimited, and/or the like. A record may also be added to debt default database 60 manually and processed for transmittal of debtor letters.

Document creation module 42 is primarily responsible for creating documents, such as debtor letters to be sent to a defaulting debtor or its representative, certified mail return receipt cards, debt verification letters, and/or the like. Such documents preferably include barcodes to facilitate association of these documents to records in debt default database 60.

Certified numbering module 64 is primarily responsible for generating and assigning a unique certified number, in compliance with United States Postal Service (USPS) regulations, for each record and each document in debt default database 60. The certified number is preferably generated in a format which may be translated into a barcode. Preferably, the generated barcode is also in compliance with USPS regulations.

Data entry module 48 is primarily used for facilitating manual entry of data into debt default management system 34. Data may be entered by any input mechanism now known or later developed. If desired, documents received from debtors, mortgagors, mortgage servicers, and/or the like, may be converted by data entry module 48 into image files and stored in debt default management system 34.

Voicemail module 62 is primarily responsible for managing voicemail messages received from a caller by voicemail system 32. Preferably, voicemail module 62 converts a voicemail message into an audio file, such as a WAV file, an MP3 file, a Windows Media file, and/or the like. The audio file is attached to an email along with the caller ID of the caller and copies of the email are sent for storage with an associated record in debt default database 60.

Email module 52 is primarily responsible for managing email messages to and from debt default management system 34. Email module 52 preferably communicates with email gateway 20. Preferably, email module 52 attaches specific identifying header information to each outgoing email. When an email is received, the header information is checked to determine if the received email is in response to an outgoing email generated by email module 52 which includes identifying header information. If a received email includes such information than it may be handled automatically and associated with a record in debt default database 60.

User module 44 is primarily responsible for enabling the system Administrator to manage user information. User module 44 allows the system Administrator to add a user, delete a user, update user information, and/or the like. User module 44 interacts with user database 58 and updates the information stored in user database 58.

Client module 46 is primarily responsible for enabling the system Administrator or other authorized user to manage client information. Client module 46 allows the system Administrator or other authorized user to add, delete, update client information, and/or the like. Client module 46 interacts with client database 56 to complete these tasks.

Billing module 54 is primarily responsible for generating invoices. Preferably the method of calculation of the amount due for providing debt default management services to a client is based on the fee arrangement with the particular client as stored in client database 56. If desired, billing module 54 may also format the invoice based on the preference of the client. For example, some recipients may prefer to have the details of the various services performed including the dates such services were performed with respect to each defaulting debtor included in the invoices. In such cases, the details and the dates of the services performed with respect to each defaulting debtor for the particular client is included in the invoice by billing module 54.

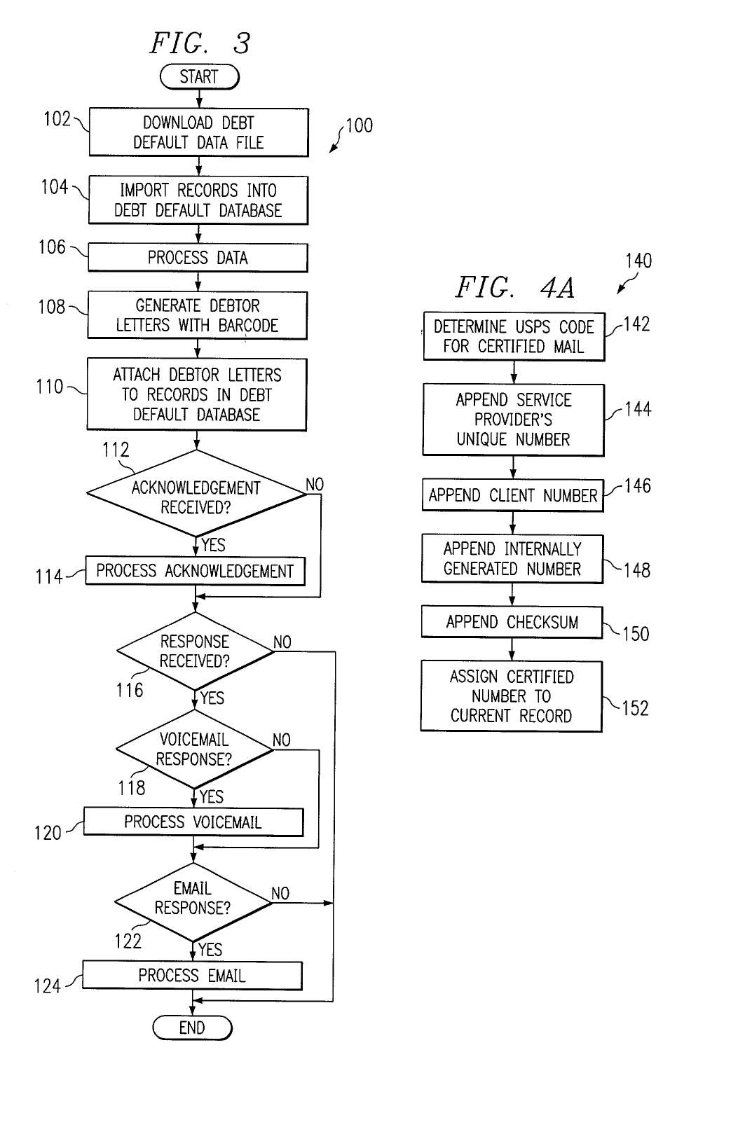

FIG. 3 is a flow chart 100 illustrating the general flow of debt default information management performed by debt default management system 34. In step 102, a debt default data file is downloaded preferably from a remote location, such as client computer 14, via communication network 16. The debt default data file to be downloaded may have been previously stored in a public folder in client computer 14. Preferably the download operation is performed by download module 38.

In an alternative embodiment, the debt default data file may be transmitted by the client via email. For example, it may be desirable for the client to transmit the debt default data file periodically to the provider of debt default management services for processing.

In step 104, the records included in the debt default data file are imported into debt default database 60, preferably by records creation module 40. Prior to importing the records in debt default database 60, a check is made to determine whether the debt default data file is corrupted due to transmission or other errors. In the preferred embodiment, two identical debt default data files are received from the client. The file sizes of the two files are compared. If the file sizes of the two files are not identical, then the records are not imported in debt default database 60 and the client is informed of the error.

If the data file is not corrupted, then preferably the user is prompted to enter the client number for the client from whom the debt default data file was received and the records in the file are imported into debt default database 60. If desired, the client number may be included in the debt default data file by the client itself prior to transmitting the file so that the appropriate fields for the client number may be automatically populated.

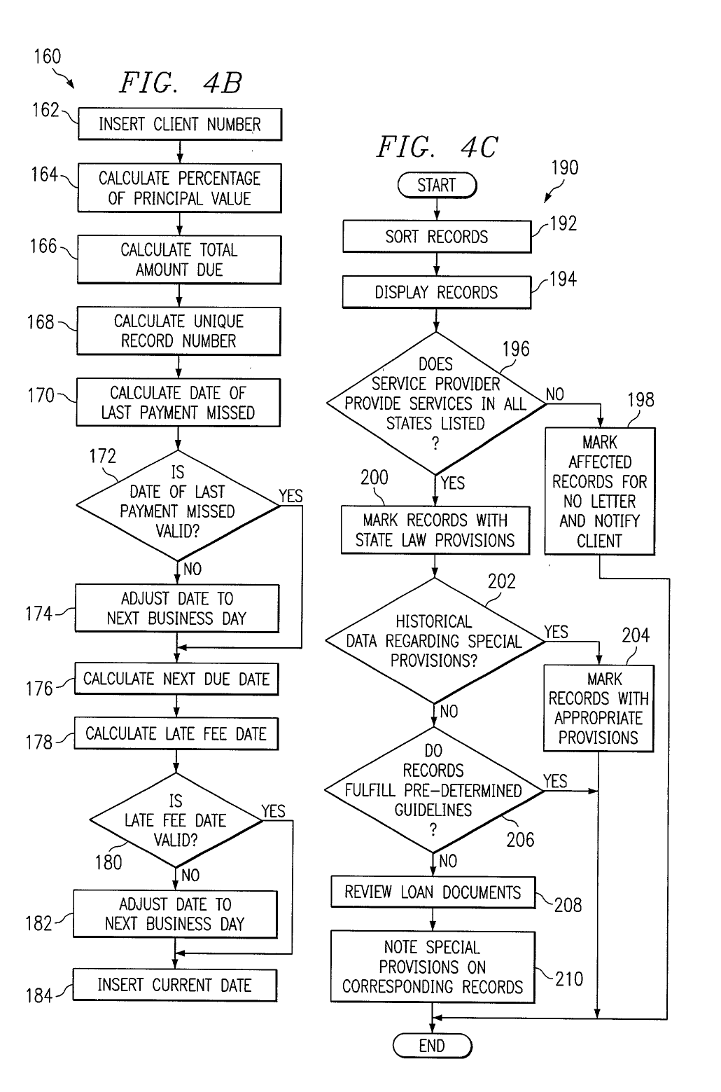

In step 106, the records imported from the debt default data file are subjected to further processing. One or more of the following processes may be performed on the records after, before or while they are being imported into debt default database 60: assigning a unique certified number to each record, assigning date and currency values to each record, marking the records for duplicate letter generation, marking the records for transmission of a special letter, reviewing the records for special provisions, segregating non-conforming addresses, querying multiple lenders database 66, identifying records with special issues, identifying extraordinary records and/or the like. A system and method for processing the records in accordance with an embodiment of the present invention is described in greater detail herein with reference to FIGS. 4A-4E.

In step 108, debtor letters to be transmitted to debtors in default and/or their representatives are generated. These debtor letters may include, for example, breach letters, notice of demand letters, and/or the like. Certified mail return receipt cards may also be created. The debtor letters and the certified mail return receipt cards preferably include barcodes.

Preferably, document creation module 42 is used to generate the debtor letters. Certified numbering module 64 is preferably used to assign a unique certified number, in compliance with USPS regulations, to each debtor letter generated from debt default management system 34. A certified number preferably comprises a USPS code for certified mail, a unique number associated with the service provider, the client number of the client, an internally assigned sequential number, and an internally calculated checksum. Preferably, the certified number is twenty digits long. Each debtor letter preferably also includes a barcode in compliance with USPS regulations and includes a human readable portion placed below the barcode. The presence of barcodes facilitates association of the debtor letters with the particular debtor's record.

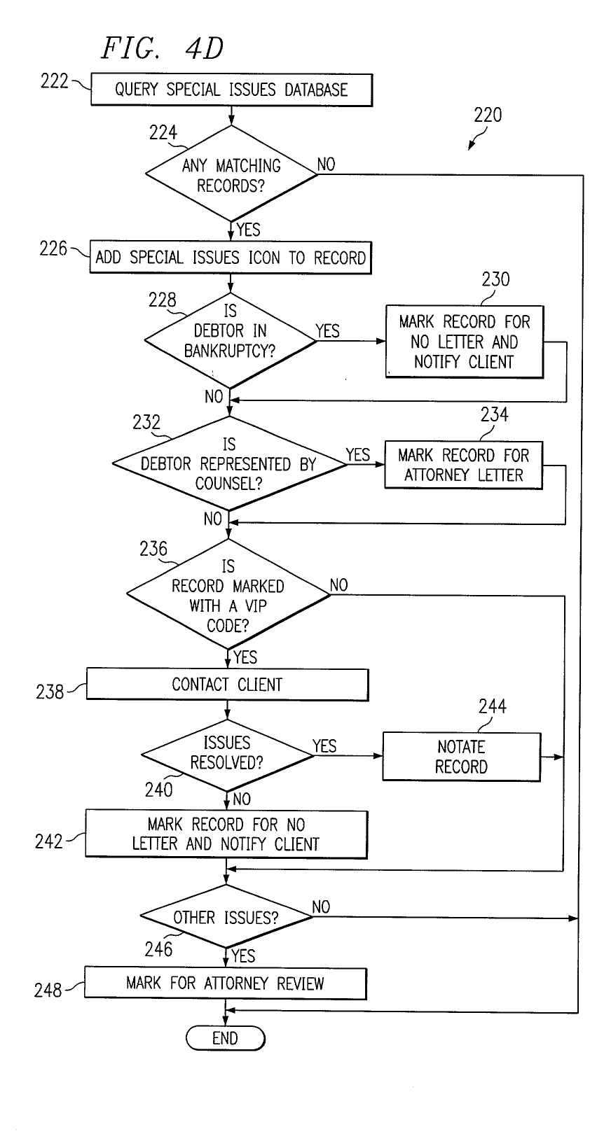

In step 110, the debtor letters that were transmitted to debtors are attached to records with matching certified numbers in debt default database 60. A system and method for attaching a debtor letter to a record in debt default database 60 is described in greater detail herein with reference to FIG. 5.

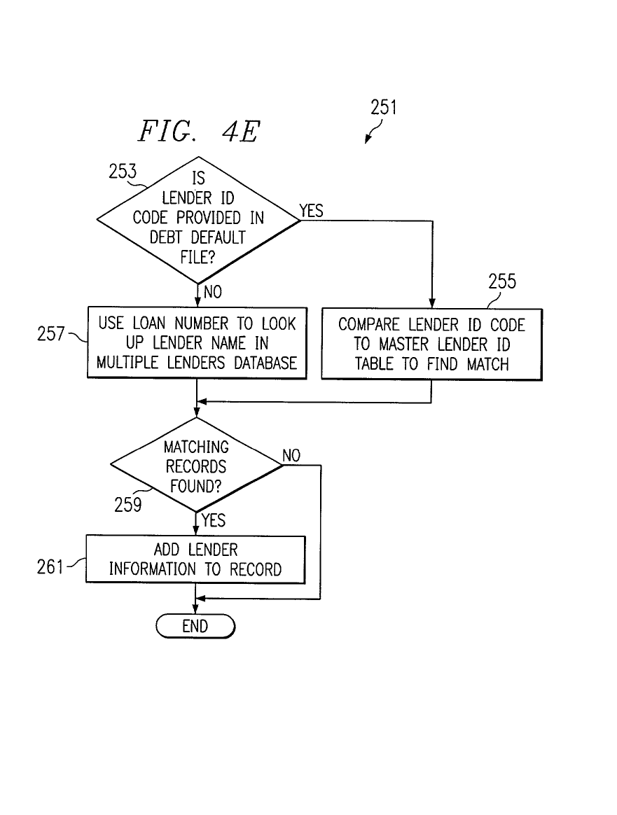

In step 112, a determination is made as to whether an acknowledgment for receipt of the debtor letters by the debtors has been received. If an acknowledgment has not been received, then the process starting at step 116 is executed. If an acknowledgement has been received, then in step 114, the received acknowledgment is processed. The received acknowledgment may be the original debtor letter with a “Return to Sender” notification or a certified mail return receipt. A system and method for processing an acknowledgment in accordance with an embodiment of the present invention is described in greater detail herein with reference to FIG. 6.

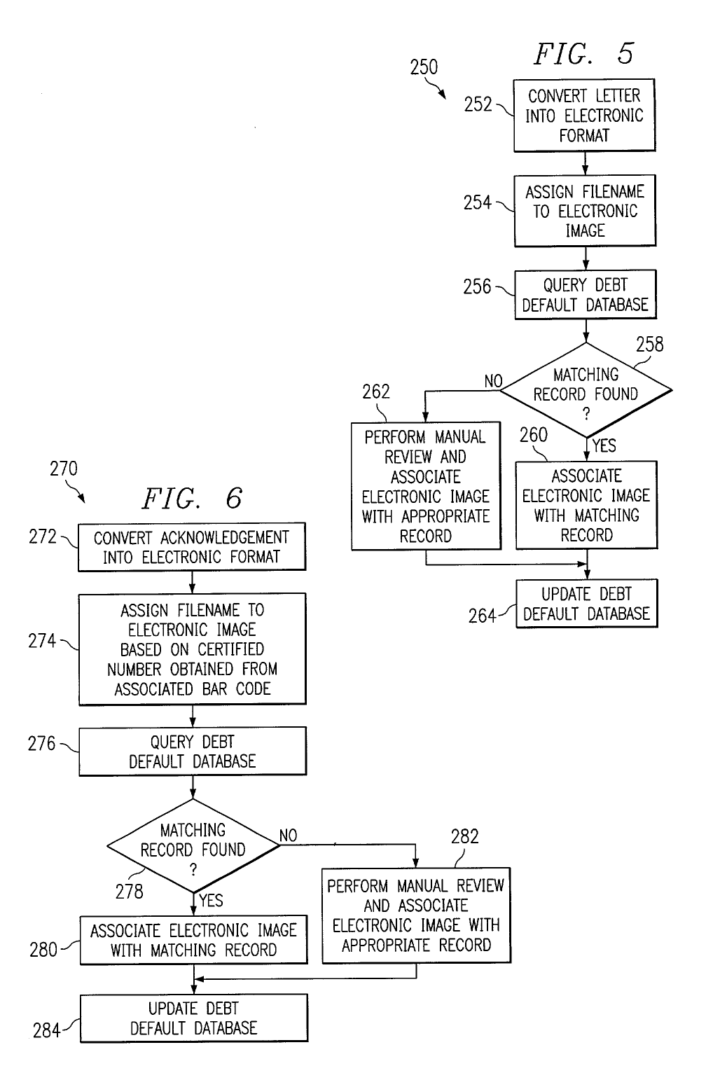

In step 116, a determination is made as to whether a response has been received in response to the debtor letters. If a response has been received, then in step 118, a determination is made as to whether the received response is in the form of a voicemail message. If the received response is in the form of a voicemail message, then in step 120, the voicemail message is processed. A system and method for processing a voicemail message in accordance with an embodiment of the present invention is described in greater detail herein with reference to FIG. 7.

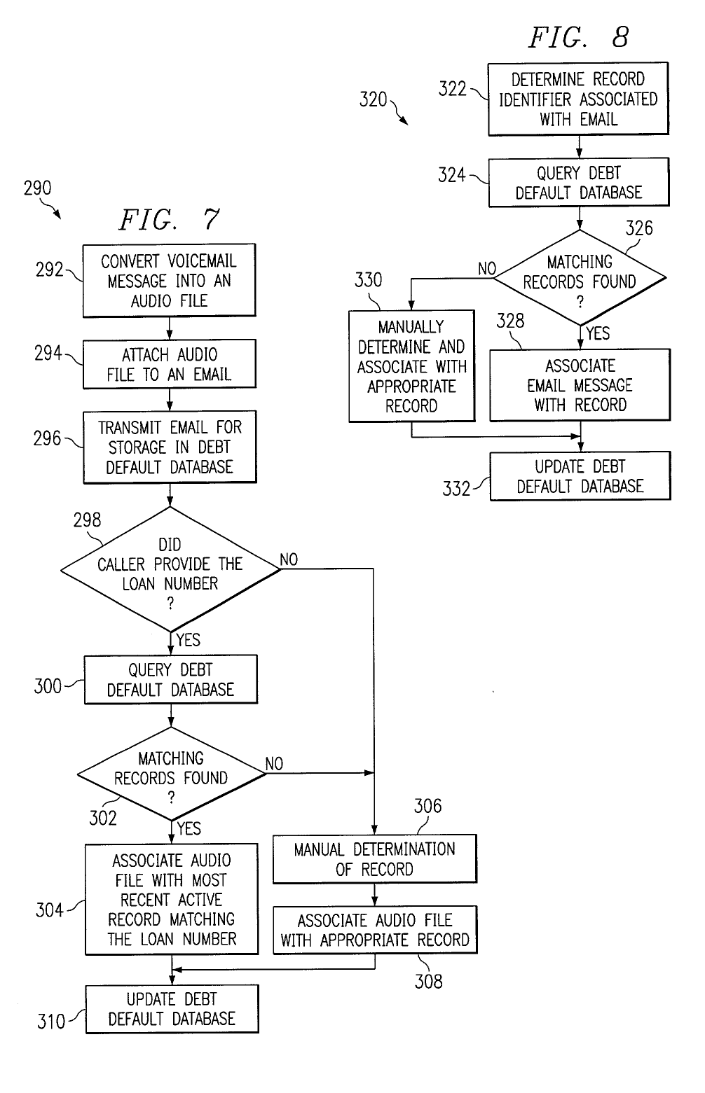

In step 122, a determination is made as to whether the received response is in the form of an email message. If the received response is in the form of an email message, then in step 124, the email message is processed. A system and method for processing an email message in accordance with an embodiment of the present invention is described in greater detail herein with reference to FIG. 8.

FIGS. 4A-4E are flow charts for processing records in debt default database 60. Each record is assigned a unique certified number, preferably by certified numbering module 64, in compliance with USPS regulations. FIG. 4A is a flowchart of a method 140 for assigning a unique certified number in accordance with an embodiment of the present invention. In step 142, the USPS code for certified mail is determined. In step 144, a unique number associated with the service provider is appended to the USPS code for certified mail. Currently the unique number associated with the service provider that is required for inclusion pursuant to USPS regulations is a Dun and Bradstreet identifier of the service provider. In step 146, the client number of the client from whom the record is obtained is appended to the number obtained after execution of step 144. In step 148, an internally generated index number is appended to the number obtained after execution of step 144. The internally generated number may be a random or a sequential number. If desired, the internally generated number may be sequential for the particular client. In step 150, a checksum is calculated and appended to the number obtained after execution of step 148. The total number of characters in the certified number generated by the above process is preferably twenty. In step 152, the certified number is assigned to the current record. Preferably, the certified number is stored in an appropriate field, say a Certified Number field, of the current record. The process starting at step 142 is repeated for each record until each record has a unique certified number assigned to it.

Date and currency values are also assigned to each record. FIG. 4B is a flowchart 160 of a method for assigning date and currency values in accordance with an embodiment of the present invention. In step 162, the client number is inserted in the appropriate field in the record. In step 164, a percentage of the principal value in default is calculated and inserted in the appropriate field. Preferably, the loan percentage value in default is calculated by dividing the amount due by the principal balance on the loan. This calculated percentage value will be used to check for accuracy of the data in the record, as described below. In step 166, a total amount due is calculated and inserted in the appropriate field. Preferably, the total amount due is calculated by adding the loan default service provider's fees for sending the breach letter to the amount due. In step 168, a unique record number is calculated and inserted in the appropriate field. In the preferred embodiment, the unique record number is calculated by appending the loan number to the client number and then appending the result to the current date. In step 170, the date of the last payment missed is calculated, preferably by applying the day from the principal due date to the current month. In step 172, a determination is made as to whether the calculated date of last payment missed is a valid date. If the date is not valid, then in step 174, the date is adjusted to the next business day. In step 176, the next due date is calculated, preferably by adding one month to the date of the last payment missed. In step 178, a late fee date is calculated, preferably by adding fifteen days to the date of the last payment missed. In step 180, a determination is made as to whether the calculated late fee date is a valid date. If the date is not valid, then in step 182, the date is adjusted to the next business day. In step 184, the current date is inserted in the appropriate field. The process starting at step 162 is repeated for each record.

Once the records have been imported into debt default database 60 and the fields populated as described above, the records may be marked for generation of duplicate letters. In the preferred embodiment, the mailing address and property address fields are compared. If the two addresses are different, then letters are sent to both addresses. If the addresses are identical, then the records with identical addresses in the mailing address and property address fields are not marked and only one letter is sent. If the values in the mailing address and property address fields are not identical, then the records are displayed with the difference in the addresses highlighted to enable a user to easily see the difference in the addresses. The user may review the displayed data to determine whether the record should be marked for transmission of duplicate letters. If it is determined that the mailing address and property address are different, then the user may mark the record to enable letters to be sent to both addresses.

Once the records have been imported into debt default database 60, they may also be marked for transmission of a special letter. In the preferred embodiment, the current records are sorted and grouped by principal due date. For each principal due date, the records may be sorted by the late fee date. A review may be made to determine whether the late fee date calculated is valid. If the calculated date is not valid, then the late fee date is corrected. If the date is valid, a review may be conducted to determine whether the late fee date is the current day. If it is determined that the late fee date is the current day, then the record is marked for transmission of a special letter. The special letter provides full disclosure to the debtor for the special late fee circumstance when the late fee date is the current day. If the late fee date is not the current day, the process terminates.

Records with non-conforming addresses may also be segregated. One or more criteria may be provided to determine whether any address does not conform to expected parameters. Records with non-conforming mailing addresses may be displayed for user review. In the preferred embodiment, if a mailing address has more than four lines, it is isolated and a manual correction is made. If a mailing address indicates delivery outside of the United States, it is isolated and the record marked for international registered mail delivery.

Debt collection is a highly regulated area. Each state has its own laws and regulations for debt collection. As such, once the records have been imported into debt default database 60, they may be reviewed and marked with special provisions, if applicable. FIG. 4C is a flowchart 190 of a method for reviewing and marking records with special provisions in accordance with an embodiment of the present invention. In step 192, the records are sorted by the state code in the property address field. In step 194, the sorted records are displayed, preferably in alphabetical order by state. In step 196, a determination is made as to whether the service provider provides services for properties located in all states listed. If the service provider does not provide services for properties located in all states listed, then in step 198, the record for the affected property is marked for no letter and the client is notified. In step 200, the remaining records are each automatically marked with state law specific provisions for the respective states.

In step 202, a determination is made as to whether any historical data regarding special provisions exist. If historical data is found, then in step 204, the records with historical data are automatically marked with the appropriate provisions.

If historical data is not found, then in step 206, a determination is made as to whether the records fulfill pre-determined guidelines. If the records fulfill predetermined guidelines, then the process terminates. For records that do not fulfill the predetermined guidelines, in step 208, the applicable loan documents are reviewed. In step 210, any special provisions found in the loan documents are noted on the corresponding record.

FIG. 4D is a flowchart 220 of a method for identifying records with special issues. In step 222, a special issues database (not shown) is queried for loan specific information on current records. Such loan specific information may be, for example, bankruptcy, representation by counsel, VIP code, and/or the like. The special issues database is created preferably based on data received from various sources. Such sources may include, for example, clients, debtors, official notices as in bankruptcy notices from courts and debtor representatives. In step 224, a determination is made as to whether any matching records were found. If a matching record is found, then in step 226, a special issues icon is added to the record to alert staff to potential conflicts. In step 228, a determination is made as to whether the debtor in the marked record is in bankruptcy. If the debtor is in bankruptcy, then in step 230, the record is marked for no letter and the client is notified. Irrespective of whether the debtor is in bankruptcy, in step 232, a determination is made as to whether the debtor is represented by legal counsel. If the debtor is represented by legal counsel, then in step 234, the record is marked so that any correspondence is sent to debtor's legal counsel rather than to the debtor. Irrespective of whether the debtor is represented by legal counsel, in step 236, a determination is made as to whether the record is marked with a VIP code. If the record is marked with a VIP code, then in step 238, the client is contacted. In step 240, a determination is made as to whether issues have been resolved. If the issues have not been resolved, then in step 242, the record is marked for no letter and the client is notified. The process starting at step 246 is then executed. If in step 240, it is determined that the issues have been resolved, then in step 244, the record is notated and the process starting at step 246 is then executed. Irrespective of whether the record is marked with a VIP code, in step 246, a determination is made as to whether other issues are involved. If the record indicates that other issues are involved, then in step 248, the record is marked for attorney review.

FIG. 4E is a flowchart 251 of a method for adding lender information to a record in accordance with an embodiment of the present invention. In step 253, a record in the debt default data file is examined to determine if a lender ID code is provided. If a lender ID code is provided, then in step 255, the lender ID code may be used to look up a master lender ID table, which may be part of debt default database 60, to determine the lender name. If a lender ID code is not provided, then in step 257, the loan number provided in the record, may be used to determine the lender name by looking up multiple lenders database 66. In step 259, a determination is made as to whether any matching records are found. If matching records are not found, then the process terminates. If a matching record is found, then in step 261, the lender information is added to the record. Lender information may then be included in any outgoing letters to the debtor, such as breach letters, or notice of demand letters. Thus, compliance with the Fair Debt Collection Practices Act may be achieved by providing the debtor with accurate information. This is also beneficial for providing services to clients servicing multiple lenders, trustees or custodians. The process starting at step 253 is repeated for each record.

Debt default database 60 may include some “extraordinary records” which are subjected to special processing and which may indicate that it might not be appropriate to send a debtor letter. “Extraordinary records” may be identified in one or more of the following ways.

1. An archive database (not shown) may be searched for records that match the last name of the debtor of the current record of debt default database 60. If such a record is found and if the record in the archive database includes comments, then an alert is added to the current record and a manual review of the previous comments is made to determine if contraindications to the alert exist. If no contraindications exist, then the client is contacted and information provided by the client is evaluated to determine if the issues have been resolved. If issues are determined to have been resolved, the next record is evaluated. If issues have not been resolved, the record is marked for no letter.

2. The current records may be searched for duplicate loan numbers. If multiple records with the same loan number are found, an alert is added to each record with the same loan number. A review of the mailing addresses may be conducted to determine if they are identical. If mailing addresses of records with the same loan numbers are identical, the records are combined into one record. If not, the next set of records with identical loan numbers are evaluated.

3. The archive database may be queried against current records for duplicate loan numbers. If records with duplicate loan numbers are found in the archive database, an alert is added to the current record. A review of past history may be conducted to determine if the debtor's payment history shows a trend of escalating defaults. If the debtor's payment history shows a trend of escalating defaults, then the client is notified.

4. The archive database may be queried against current records for duplicate loan numbers with comments. If such a record is found, an alert is added to the current record. A review of the previous comments may be made to determine if contraindications to the alert exist. If no contraindications exist, then the client is contacted and information provided by the client is evaluated to determine if the issues have been resolved. If issues are determined to have been resolved, the next record is evaluated. If issues have not been resolved, the record is marked for no letter.

5. The archive database may be queried against current records for duplicate loan numbers and principal due dates. If such a record is found in the archive database, an alert is added to the current record. A review may be conducted to determine if a breach letter has already been sent with the current information. If a breach letter with current information has already been sent, the client is contacted and information provided by the client is evaluated to determine if the issues have been resolved. If issues are determined to have been resolved, the next record is evaluated. If issues have not been resolved, the record is marked for no letter.

6. Debt default database 60 may be searched for records that indicate an amount due of less than a minimum threshold, say 1%, or more than a maximum threshold, say 7%, of the principal balance. If such a record is found, an alert is added to the record. The client may be contacted and information provided by the client evaluated to determine if the issues have been resolved. If issues are determined to have been resolved the next record is evaluated. If issues have not been resolved, the record is marked for no letter.

FIG. 5 is a flowchart 250 of a method for attaching a debtor letter to a record in debt default database 60 in accordance with an embodiment of the present invention. In step 252, the debtor letter is converted into an electronic image, such as TIF, GIF, PDF, and/or the like. In step 254, a filename is assigned to the electronic image, preferably based upon the unique certified number associated with the debtor letter. In step 256, debt default database 60 is queried for records with certified numbers matching the filename of the electronic image. In the preferred embodiment, each of the logical databases of debt default database 60 is queried. In an alternative embodiment, multiple physical databases may be queried, if desired. In step 258, a determination is made as to whether any matching record is found. If a matching record is found, then in step 260, the electronic image is associated with the matching record in debt default database 60. Preferably, this is accomplished by storing the electronic image of the debtor letter in the record. If matching records do not exist, then in step 262, a manual review is performed and the electronic image is associated with the appropriate record in debt default database 60. In step 264, the updated record is written to debt default database 60.

FIG. 6 is a flowchart 270 of a method for processing an acknowledgment in accordance with an embodiment of the present invention. In step 272, the acknowledgment is scanned into an electronic image, such as TIF, GIF, PDF, and/or the like. In step 274, a filename is assigned to the electronic image, preferably based upon the unique certified number associated with the acknowledgment. In the preferred embodiment, a barcode reader, such as barcode reader 30 (FIG. 1) may be used to scan the barcode on the acknowledgment. The barcode includes the certified number associated with the acknowledgment. In step 276, debt default database 60 is queried for records with certified numbers matching the filename of the electronic image. In the preferred embodiment, each of the logical databases of debt default database 60 is queried. In an alternative embodiment, multiple physical databases may be queried, if desired. In step 278, a determination is made as to whether any matching record is found. If a matching record is found, then in step 280, the electronic image is associated with the matching record in debt default database 60. Preferably, this is accomplished by storing the electronic image of the acknowledgment in the record. If matching records do not exist, then in step 282, a manual review is performed and the electronic image is associated with the appropriate record in debt default database 60. In step 284, the updated record is written to debt default database 60. Steps 272 through 284 are preferably repeated for each acknowledgment received.

FIG. 7 is a flowchart 290 of a method for processing a voicemail message in accordance with an embodiment of the present invention. Each client may have a dedicated phone number assigned to it. Thus, a caller, for example, a debtor or a representative of the debtor may call the dedicated phone number to leave a voicemail message on voicemail system 32 (FIG. 1). The caller may be prompted to enter the loan number in reference to which they are calling. Voicemail system 32 preferably also collects caller ID information.

In step 292, the voicemail message is converted into an audio file, preferably by voicemail module 62. In step 294, the audio file is attached to an email containing the caller ID of the caller and the loan number, if any. In step 296, a copy of the email is sent to debt default database 60. In step 298, a determination is made as to whether the caller entered the loan number. If the caller entered the loan number, then in step 300, debt default database 60 is queried for records matching the input loan number. In the preferred embodiment, each of the logical databases of debt default database 60 is queried. In an alternative embodiment, multiple physical databases may be queried, if desired. In step 302, a determination is made as to whether any matching records are found. If matching records are found, then in step 304, the audio file is associated with the most recent active record matching the loan number. Preferably, this is accomplished by storing the audio file in the record. If no loan number was entered by the caller or if no matching records are found, then in step 306, a manual review of the voicemail may be made to determine the correct record with which to associate the audio file. For example, the caller ID may be used to match against the stored telephone numbers of the records. In step 308, the audio file is associated with the appropriate record. In step 310, the updated record is written to debt default database 60.

A copy of the email may also be sent to a particular agent of the service provider assigned to service the particular client. The employee reviews the voicemail message and determines if a response is required. If no response is required, the agent notates the appropriate record in debt default database 60 that no action was taken on the voicemail message. If a response is required, the agent responds to the voicemail message and then notates the action taken on the voicemail message. After the record has been notated for action or inaction, the updated record is written to debt default database 60. If desired, a copy of the email may also be sent to the client for review.

FIG. 8 is a flowchart 320 of a method for processing an auto-email message in accordance with an embodiment of the present invention. When an email is transmitted from debt default management system 34, a record identifier is appended to the subject line of the outgoing email. The recipient of the email responds to the email by hitting a reply button. The recipient may be a client of the service provider, opposing counsel, a debtor, and/or the like. The return email arrives at email gateway 20. The email is transferred by email gateway 20 to email module 52. In step 322, email module 52 determines the record identifier of the email, preferably by examining the subject line of the email. In step 324, debt default database 60 is queried for a matching record. In the preferred embodiment, each of the logical databases of debt default database 60 is queried. In an alternative embodiment, multiple physical databases may be queried, if desired. In step 326, a determination is made as to whether any matching records are found. If a matching record is found, then in step 328, the email is associated with the matching record preferably by linking it to the transmitted email message as a reply thread. If no matching records are found, then in step 330, an employee may determine and associate the email to the appropriate record of debt default database 60. In step 332, the updated record is written to debt default database 60. Thus, in a preferred embodiment, incoming email messages may be automatically processed and associated with the appropriate record. A single email address may be provided for multiple clients and email module 52 automatically associates the received email to the record of the appropriate client.

A user may manually enter data by inputting the data in central database 50 or by associating image files of documents received from debtors, mortgagors, mortgage servicers, lenders, and/or the like, with records of debt default database 60. Data entry module 48 of debt default management system 34, then preferably adds the time, date, and user ID to the record that was modified. A determination is made, preferably by data entry module 48, to determine if certain fields that require special handling were modified. If any of the fields requiring special handling were modified, then the modified record is appropriately marked to indicate the record's special status. The updated record is written to debt default database 60.

A preferred embodiment of the present invention allows users with the appropriate permissions to perform editing of the records over the Internet. Moreover, a search engine interface (not shown) allows a user to perform searches on information in debt default database 60 over the Internet, thus facilitating retrieval of information by authorized individuals. The search may be performed on any of the fields in debt default database 60.

Although the preferred embodiment of the present invention has been described above with different modules performing different operations, the invention is not so limited. One or more of the above described modules may be combined without departing from the scope of the present invention. Furthermore, although the preferred embodiment of the present invention has been described above with different databases storing different types of information, the invention is not so limited. One or more of the above described databases may be combined without departing from the scope of the present invention. Furthermore, if desired, the teachings of the present invention may be used to manage and keep track of information in various types of fields related to debt collection, for example, credit card debts, commercial debts, probate claims, and/or the like.

While the invention has been particularly shown and described by the foregoing detailed description, it will be understood by those skilled in the art that various other changes in form and detail may be made without departing from the spirit and scope of the invention.

What is claimed is:

1. A method for management of debt information by a service provider, comprising:
receiving a debt default data file, said debt default data file comprising a plurality of records, each record having data associated with a defaulted loan;
importing said plurality of records into a debt default database;
generating a plurality of unique certified numbers, each certified number including an identifier of a lender of the defaulted loan and an identifier of the service provider;
assigning each of said plurality of unique certified numbers to respective ones of said plurality of records; and
generating correspondence and communicating with debtors associated with the defaulted loans using the assigned unique certified numbers.

2. The method of claim 1, wherein said debt default data file is received from said client over a communication network.

3. The method of claim 1, wherein said debt default data file is a text file.

4. The method of claim 1, wherein generating the plurality of unique certified numbers comprises:
(a) appending an identifier of the service provider to a postal code to generate a first intermediate code;
(b) appending a lender identifier unique to the lender to said first intermediate code to generate a second intermediate code;
(c) appending an internally generated index number to said second intermediate code to generate said unique certified number; and
(d) repeating steps (a) through (c) for generating each of said plurality of unique certified numbers.

5. The method of claim 1, wherein generating the plurality of unique certified numbers comprises:
(a) determining a postal code;
(b) appending an identifier of the service provider to said postal code to generate a first intermediate code;
(c) appending a lender identifier unique to the lender to said first intermediate code to generate a second intermediate code;
(d) appending an internally generated index number to said second intermediate code to generate a third intermediate code;
(e) appending a checksum to said third intermediate code to generate said unique certified number; and
(f) repeating steps (a) through (e) for generating each of said plurality of unique certified numbers.

6. The method of claim 1, further comprising determining data integrity of said plurality of records of said debt default data file prior to said importing step.

7. The method of claim 6, wherein determining data integrity comprises:
receiving a copy of said debt default data file;
comparing a size of said copy of said debt default data file with a size of said debt default data file; and
importing said plurality of records into said debt default database in response to said size of said copy of said debt default data file being identical to said size of said debt default data file.

8. The method of claim 1, further comprising generating a debtor letter for selected ones of said plurality of records of said debt default database.

9. The method of claim 8, further comprising assigning the unique certified number to said debtor letter.

10. The method of claim 8, further comprising:
generating a barcode representation of the unique certified number; and
associating said generated barcode with said debtor letter.

11. The method of claim 10, further comprising associating said debtor letter with a corresponding record in said debt default database.

12. The method of claim 1, further comprising:
receiving, in response to an originating email message, a reply email message comprising a record identifier corresponding to a record of said plurality of records;
querying said debt default database for records matching said record identifier; and
automatically associating said reply email message with a record in said debt default database matching said record identifier.

13. The method of claim 12, further comprising transmitting said originating email message including said record identifier.

14. The method of claim 12, further comprising linking said reply email message to said originating email message as a reply thread.

15. The method of claim 1, further comprising:
transmitting an originating email message including a record identifier corresponding to a record of said plurality of records;
automatically associating said originating email message with said record of said plurality of records;
receiving a reply email message comprising said record identifier; and
automatically associating said reply email message with said record of said plurality of records.

16. The method of claim 1, further comprising:
receiving a voicemail message from a caller regarding said defaulted loan; and
automatically associating said voicemail message with a record of said plurality of records.

17. The method of claim 1, further comprising:
retrieving information from said debt default database in response to receiving a request for information over a communication network; and
transmitting said retrieved information over said communication network.

18. The method of claim 17, wherein said communication network comprises the Internet.

19. The method of claim 1, further comprising:
receiving updated information regarding selected ones of said plurality of records over a communication network; and
updating said selected ones of said plurality of records in response to receiving said updated information.

20. The method of claim 1, further comprising adding lender specific information to said plurality of records for inclusion in said correspondence with debtors.

21. The method of claim 1, further comprising:
querying a multiple lenders database for lender records with loan numbers matching said defaulted loans;
retrieving lender specific information on a plurality of lenders from said matching lender records; and
updating said plurality of records of said debt default database with respective ones of said retrieved lender specific information.

22. A system for management of debt information by a service provider, comprising:
a debt default database for storing a plurality of records, each record having data associated with a defaulted loan;
a certified numbering module operable to generate a plurality of unique certified numbers, each certified number including an identifier of a lender of the defaulted loan and an identifier of the service provider, said certified numbering module further operable to assign each of said plurality of unique certified numbers to respective ones of said plurality of records; and
a document creation module operable to create correspondence to be communicated to debtors associated with the defaulted loans using the assigned unique certified numbers.

23. The system of claim 22, further comprising an email module operable to automatically associate a received email comprising a record identifier with one of said plurality of records based at least in part on said record identifier.

24. The system of claim 23, said email module further operable to link said received email with an originating email.

25. The system of claim 23, further comprising a voicemail module operable to automatically associate a voicemail message regarding said defaulted loan with a record of said plurality of records.

26. The system of claim 22, wherein said debt default database is logically subdivided into a plurality of databases, each of said plurality of databases corresponding to a client of said service provider.

27. The system of claim 22, further comprising a records creation module operable to extract records from at least one debt default data file for storing in said debt default database.

28. The system of claim 22, further comprising a multiple lenders database for storing information on a plurality of lenders.

29. A method for management of voicemail messages in a debt default management system, comprising:
receiving a voicemail message from a caller regarding a loan;
prompting said caller to enter a loan number for said loan;
receiving said loan number;
converting said voicemail message into an audio file; and
automatically associating said audio file to a record in a debt default database based at least in part on said received loan number, said record including default information about said loan.

30. The method of claim 29, further comprising collecting a caller ID of said caller.

31. The method of claim 29, further comprising attaching said audio file to an email message including said received loan number.

32. The method of claim 29, further comprising querying said debt default database for records matching said received loan number.

33. The method of claim 32, further comprising associating said audio file with the most recent record matching said received loan number.
